(19) United States
(12) Patent Application Publication
(10) Pub. No.: US 2016/0121959 A1
(43) Pub. Date: May 5, 2016

(54) URBAN QUADRACYCLE

(71) Applicant: Rafael Jimenez MARTINEZ, Chula Vista, CA (US)

(72) Inventor: Rafael Jimenez Martinez, Chula Vista, CA (US)

(21) Appl. No.: 14/889,812

(22) PCT Filed: May 9, 2014
(86) PCT No.: PCT/US2014/037592

§ 371 Date: Nov. 6, 2015

Related U.S. Application Data
(60) Provisional application No. 61/821,916, filed on May 10, 2013.

(51) Int. Cl. B62K 17/00; B62K 21/12

(52) U.S. Cl. CPC B62K 17/00; B62K 21/12; B62K 2005/001

(57) ABSTRACT

The device disclosed herein is a quadracycle including a forward assembly and a rear assembly. The forward assembly includes a forward frame, a right suspension assembly connecting a forward right wheel assembly to the forward frame, and a left suspension assembly connecting a forward left wheel assembly to the forward frame. The rear assembly includes a right rear frame, a left rear frame, a rear tube connector connecting the right frame to the left frame, and a rear suspension assembly connecting the forward frame to the right rear frame and the left rear frame.

### TECHNICAL FIELD

The present invention relates generally to cycles and is directed to a quadracycle or cycle with four wheels.

### BACKGROUND

Cycles, such as bicycles may not balance on their own and may be unstable. Cycles with four wheels may be sturdy and may better support the operator. One such cycle is discussed in U.S. Pat. No. 4,674,762 to L. Nelson that discloses a four-wheel human powered vehicle including a frame for supporting the operator of the cycle in a substantially recumbent position, rear wheels mounted on the sides of the frame, two arms mounted on the frame and extending forwardly and outwardly therefrom, and each mounting a front wheel, steering means connected to the front wheels and controllable by the operator, and a crank boom extending forwardly from the frame and supporting a crank mounting foot pedals, and a drive attached thereto for transferring the power to one of the rear wheels.

### SUMMARY

A quadracycle is disclosed herein. In one embodiment, the quadracycle includes a forward assembly and a rear assembly. The forward assembly includes a forward frame, a right suspension assembly connecting a forward right wheel assembly to the forward frame, and a left suspension assembly connecting a forward left wheel assembly to the forward frame. The rear assembly includes a right rear frame, a left rear frame, a rear tube connector connecting the right frame to the left frame, and a rear suspension assembly connecting the forward frame to the right rear frame and the left rear frame.

### BRIEF DESCRIPTION OF THE DRAWINGS

FIG. 1 is a perspective view of an embodiment of a quadracycle.

FIG. 2 is a side view of a portion of the quadracycle of FIG. 1.

FIG. 3 is an alternative perspective view of the front of the quadracycle 50 of FIG. 1.

FIG. 4 is an alternative perspective view of the top of the quadracycle of FIG. 1.

FIG. 5 is a perspective view of the aft side of a portion of forward assembly of FIG. 1.

FIG. 6 is a perspective view of the rear assembly 300 of FIG. 1.

### DETAILED DESCRIPTION

The device disclosed herein is a quadracycle including four wheels, forward and rear suspension, and a steering mechanism. In embodiments, the forward suspension includes a right suspension assembly and a left suspension assembly. The independent suspension assemblies and the rear suspension may reduce the bumps and vibrations felt by the rider. The four wheels may provide stability to carry gear such as a surfboard or other sporting equipment, groceries, or a second rider on the quadracycle.

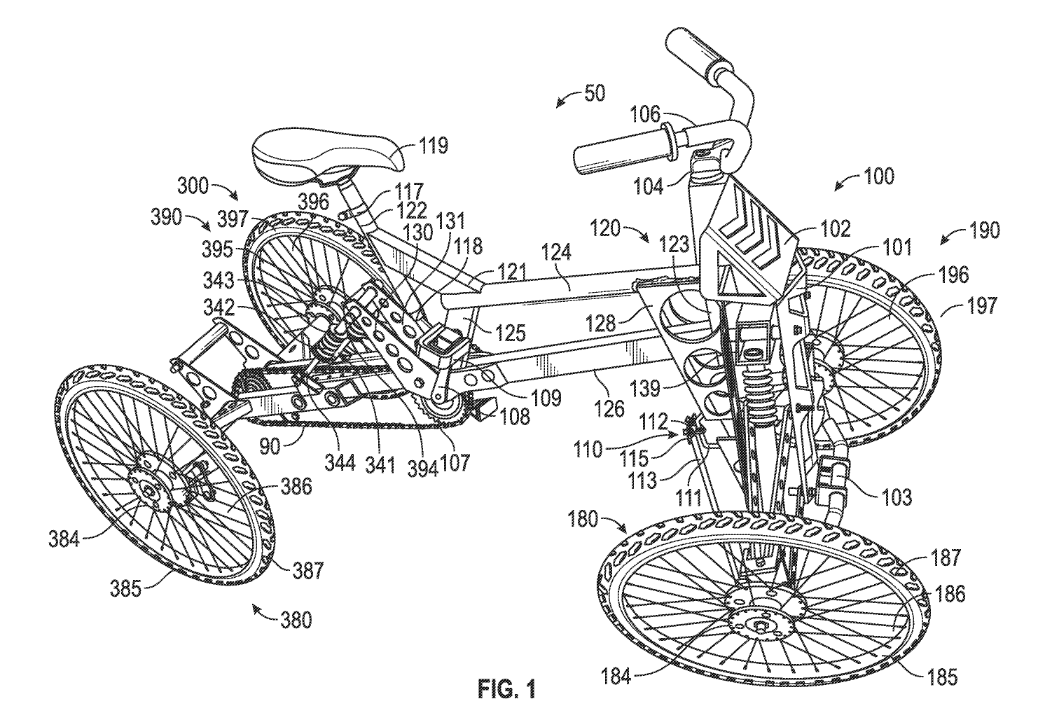

FIG. 1 is a perspective view of an embodiment of a quadracycle 50. Some of the surfaces may have been left out or exaggerated (here and in other figures) for clarity and ease of explanation. Also, the disclosure may reference a forward, aft, right, left, up, and down directions. Generally, all references to “forward,” “aft,” “right,” “left,” “up,” and “down are relative to a rider sitting on the seat 119 in position to operate the quadracycle 50 with the four tires contacting the ground, unless specified otherwise.

The quadracycle 50 includes a forward assembly 100 and a rear assembly 300. Forward assembly 100 may include a forward frame 120, a right suspension assembly 140, a left suspension assembly 160, a face plate 101, a head plate 102, a bumper 103, a stem 104, a handle bar 106, a forward suspension bracket 139, a steering assembly 110, a forward right wheel assembly 180, a forward left wheel assembly 190, a forward chain wheel, crank arms 108, pedals 109, a seat post 118, and a seat 119.

Forward frame 120 may include a cross tube 124, a down tube 126, a tube support member 125, a seat support member 121, a seat tube 122, a right forward bracket 128, a left forward bracket 129, a head tube 123, a right aft bracket 130, and a left aft bracket 131. Cross tube 124 may extend in a first horizontal direction from forward to aft. In the embodiment illustrated, cross tube 124 is a circular tube. In other embodiments, cross tube 124 may be a square or rectangular tube. Down tube 126 may extend below cross tube 124 and may be partially angled down such that the forward end of down tube 126 is closer to cross tube 124 than the aft end of down tube 126. In the embodiment illustrated, down tube 126 is a rectangular tube with the cross-section being wider in the vertical direction. In other embodiments, down tube 126 may be a square or circular tube or may be a rectangular tube oriented with the cross-section being wider in a second horizontal direction, perpendicular to the first horizontal direction.

Tube support member 125 may extend from the cross tube 124 to the down tube 126. The connection of tube support member 125 to the cross tube 124 may be distal to head tube 123, such as being at the aft end or near the aft end of cross tube 124. The connection of tube support member 125 to the down tube 126 may also be distal to head tube 123, such as being at the aft end or near the aft end of down tube 126. The connection between tube support member 125 and cross tube 124 may be forward and above the connection between tube support member 125 and down tube 126. In the embodiment illustrated, tube support member 125 is a rectangular tube. In other embodiments, tube support member 125 may be a square or circular tube.

Seat support member 121 may extend from the aft end or near the aft end of cross tube 124 in the upward and aft directions. Seat support member 121 may connect to cross tube 124 adjacent the connection between tube support member 125 and cross tube 124. In the embodiment illustrated, seat support member 121 is a rectangular tube. In other embodiments, seat support member may be a square or circular tube. Seat tube 122 may connect to seat support member 121 at the end opposite and distal to the connection of seat support member 121 and cross tube 124. Seat tube 122 may be oriented in the vertical direction and configured to receive seat post 118. Seat tube 122 may be a circular or cylindrical tube.

Head tube 123 may extend vertically and connect to a forward end of cross tube 124, opposite the connection between cross tube 124 and tube support member 125. Head tube 123 may also connect to a forward end of down tube 126 opposite the connection between down tube 126 and tube support member 125, as well as below the connection between cross tube 124 and head tube 123. In the embodiment illustrated, head tube 123 is a square tube. In other embodiments, head tube 123 may be a circular tube.

Right forward bracket 128 may connect to cross tube 124 along the right side of the forward end of cross tube 124. Right forward bracket may be an ‘L’ shaped bracket extending down in a vertical direction, perpendicular to the first horizontal direction and the second horizontal direction, from the right side of cross tube 124 adjacent head tube 123. Right forward bracket 128 may also connect to the right side of head tube 123 and to the right side of the forward end of down tube 126. A first leg of the ‘L’ shape may span in the first horizontal direction and may narrow as it extends down. A second leg of the ‘L’ shape may span to the right, out and away, in the second horizontal direction, from cross tube 124, down tube 126 and head tube 123. Right forward bracket 128 may include various features including holes and cutouts to connect to the right suspension assembly 140 and to reduce the weight of right forward bracket 128.

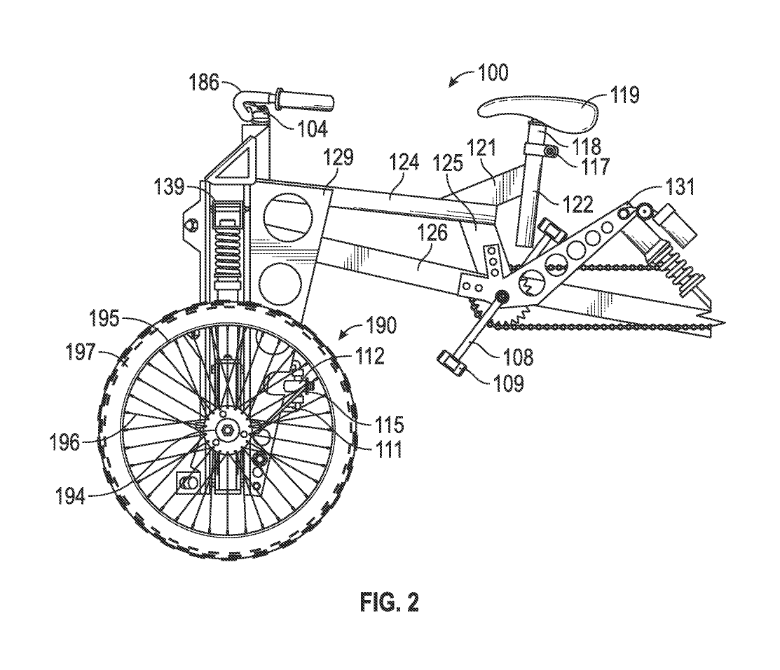

FIG. 2 is a side view of a portion of the quadracycle 50 of FIG. 1. Referring to FIG. 2, left forward bracket 129 may connect to cross tube 124 along the left side of the forward end of cross tube 124, opposite right forward bracket 128. Left forward bracket may be an ‘L’ shaped bracket extending down from the left side of cross tube 124 adjacent head tube 123 in the vertical direction. Left forward bracket 129 may also connect to the left side of head tube 123 and to the left side of the forward end of down tube 126. A first leg of the ‘L’ shape may span in the first horizontal direction and may narrow as it extends down. A second leg of the ‘L’ shape may span to the left, out and away, in the second horizontal direction, from cross tube 124, down tube 126 and head tube 123. Left forward bracket 129 may include various features including holes and cutouts to connect the left suspension assembly 160 and to reduce the weight of left forward bracket 129.

Referring again to FIG. 1, right aft bracket 130 may be a three pronged bracket with a first prong extending along and connecting to the right side of the aft end of down tube 126, with a second prong extending along and connecting to the right side of the bottom end of tube support member 125, and with a third prong extending up and aft from the joint of the other two prongs. Right aft bracket 130 may include various features including holes and cutouts.

Referring again to FIG. 2, left aft bracket 131 may be a three pronged bracket with a first prong extending along and connecting to the left side of the aft end of down tube 126, with a second prong extending along and connecting to the left side of the bottom end of tube support member 125, and with a third prong extending up and aft from the joint of the other two prongs. Left aft bracket 131 may be situated on the side opposite right aft bracket 130. Left aft bracket 131 may include various features including holes and cutouts. The various connections described above between the parts or elements of forward frame 120 may be metallurgically bonded, such as by molding and welding. Right aft bracket 130 and left aft bracket 131 may provide support and a connection point for forward assembly 100 and rear assembly 300.

Forward suspension bracket 139 connects to forward frame 120 and may be connected, such as by bolting, to the second legs of right forward bracket 128 and left forward bracket 129. Forward suspension bracket 139 may extend in the second horizontal direction, the same direction as the second legs of right forward bracket 128 and left forward bracket 129. In the embodiment shown, forward suspension bracket 139 is a rectangular tube. The ends of forward suspension bracket 139 may be cut at an angle such that the face on view of forward suspension bracket 139 is a trapezoidal shape with the longer base of the trapezoid being below the shorter base of the trapezoid.

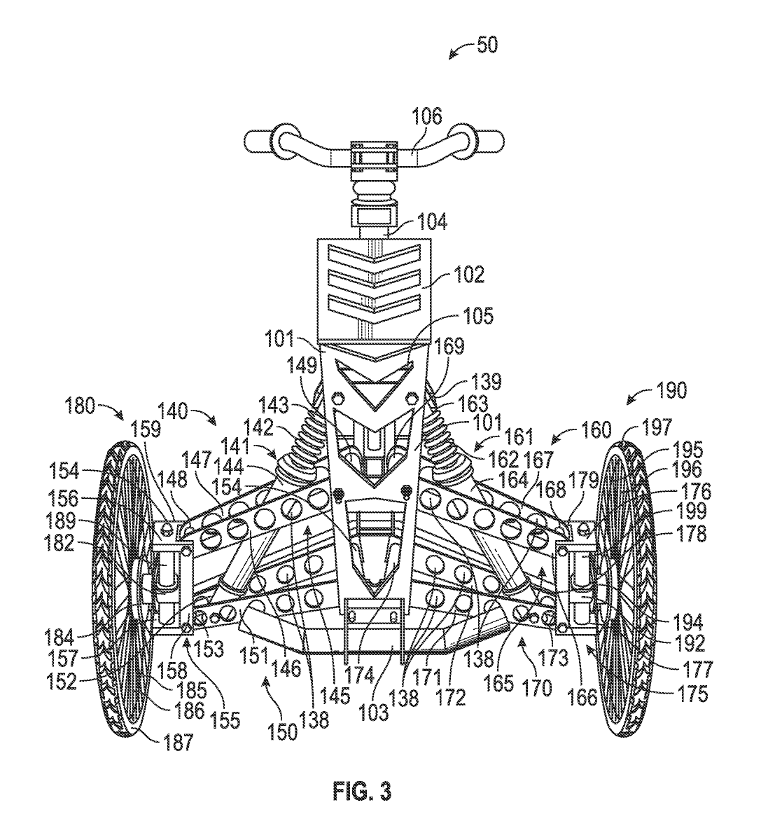

FIG. 3 is an alternative perspective view of the front of the quadracycle 50 of FIG. 1. Referring to FIG. 3, face plate 101 may be connected to forward suspension bracket 139, such as by bolting. Face plate 101 may be located adjacent the forward face of forward suspension bracket 139. Face plate 101 may be a thin piece of sheet metal and may extend down at the front of quadracycle 50. Face plate 101 may include decorative features 105, such as holes and cutouts. Head plate 102 may be located above face plate 101. Head plate 102 may also be a thin peace of sheet metal and my also include decorative features 105. Head plate 102 may be secured or connected to head tube 123. Bumper 103 may be located at the bottom of face plate 101 and may be bolted or otherwise connected to face plate 101.

Right suspension assembly 140 connects to forward frame 120 and to forward suspension bracket 139, and connects them to forward right wheel assembly 180. Right suspension assembly 140 may include a right upper wing 145, a right lower wing 150, a right wheel bracket 155, and a right shock absorber 141. Right upper wing 145 connects forward frame 120 to right wheel bracket 155. Right upper wing 145 may include a right upper wing forward arm 146, a right upper wing aft arm 147, a right upper wing inner tube 149 and a right upper wing outer tube 148. Right upper wing forward arm 146 may extend from the forward end of right upper wing inner tube 149 to the forward end of right upper wing outer tube 148. Right upper wing aft arm 147 may extend from the aft end of right upper wing inner tube 149 to the aft end of right upper wing outer tube 148. Right upper wing forward arm 146 and right upper wing aft arm 147 may be rectangular pieces of sheet metal, such as aluminum plates, and may have rounded corners or ends. Right upper wing forward arm 146 and right upper wing aft arm 147 may include multiple cutouts 138, such as holes. Right upper wing inner tube 149 and right upper wing outer tube 148 may join right upper wing forward arm 146 and right upper wing aft arm 147 together. Right upper wing inner tube 149 and right upper wing outer tube 148 may be circular tubes and may be metallurgically bonded, such as by welding or brazing, to right upper wing forward arm 146 and right upper wing aft arm 147. Right upper wing outer tube 148 may be distal to right upper wing inner tube 149.

Right upper wing 145 may connect to right forward bracket 128 adjacent right upper wing aft arm 147 and to face plate 101 adjacent right upper wing forward arm 146 with right upper wing inner tube 149 extending between right forward bracket 128 and face plate 101. Right upper wing 145 may be bolted or otherwise connected to forward bracket 128 and face plate 101 at right upper wing inner tube 149. Bearings may be placed to facilitate rotation between right upper wing inner tube 149 and the bolt or connector. Right upper wing 145 may be bolted or otherwise connected to right wheel bracket 155 at right upper wing outer tube 148. Bearings may also be placed to facilitate rotation between right upper wing outer tube 148 and the bolt or connector.

Right lower wing 150 may be located below right upper wing 145. Right lower wing 150 also connects forward frame 120 to right wheel bracket 155. Right lower wing 150 may include a right lower wing forward arm 151, a right lower wing aft arm 152, a right lower wing inner tube 154 and a right lower wing outer tube 153. Right lower wing forward arm 151 may extend from the forward end of right lower wing inner tube 154 to the forward end of right lower wing outer tube 153. Right lower wing aft arm 152 may extend from the aft end of right lower wing inner tube 154 to the aft end of right lower wing outer tube 153. Right lower wing forward arm 151 and right lower wing aft arm 152 may be rectangular pieces of sheet metal, such as aluminum plates, and may have rounded corners or ends. Right lower wing forward arm 151 and right lower wing aft arm 152 may include multiple cutouts 138. Right lower wing inner tube 154 and right lower wing outer tube 153 may join right lower wing forward arm 151 and right upper wing aft arm 147 together. Right lower wing inner tube 154 and right lower wing outer tube 153 may be circular tubes and may be metallurgically bonded, such as by welding or brazing, to right lower wing forward arm 151 and right lower wing aft arm 152. Right lower wing outer tube 153 may be distal to right lower wing inner tube 154.

Right lower wing 150 may connect to the bottom of forward bracket 128 adjacent right lower wing aft arm 152 and to the bottom of face plate 101 adjacent right lower wing forward arm 151 with right lower wing inner tube 154 extending between right forward bracket 128 and face plate 101 at right lower wing inner tube 154. Right lower wing inner tube 154 may also be located below right upper wing inner tube 149. Right lower wing 150 may be bolted or otherwise connected to right forward bracket 128 and face plate 101. Bearings may be placed to facilitate rotation between right lower wing inner tube 154 and the bolt or connector. Right lower wing 150 may be bolted or otherwise connected to right wheel bracket 155 at right lower wing outer tube 153. Bearings may also be placed to facilitate rotation between right lower wing outer tube 153 and the bolt or connector.

Right wheel bracket 155 may include a right bracket upper plate 156, a right bracket lower plate 157, a right forward bracket arm 158, and a right aft bracket arm 159. Right bracket upper plate 156 and right bracket lower plate 157 may be square or rectangular plates. Right bracket upper plate 156 and right bracket lower plate 157 may be parallel with a vertical gap there between. Right forward bracket arm 158 may be a vertical plate with the flat faces of the plate facing in the forward and aft directions. The upper and outer edge of right forward bracket arm 158 may connect to the forward and inner portion of right bracket upper plate 156. The lower and outer edge of right forward bracket arm 158 may connect to the forward and inner portion of right bracket lower plate 157.

Right aft bracket arm 159 may be a vertical plate with the flat faces of the plate facing in the forward and aft directions. The upper and outer edge of right aft bracket arm 159 may connect to the aft and inner portion of right bracket upper plate 156. The lower and outer edge of right aft bracket arm 159 may connect to the aft and inner portion of right bracket lower plate 157. Right bracket upper plate 156, right bracket lower plate, right forward bracket arm 158, and right aft bracket arm 159 may be a single integral piece or may be metallurgically bonded, such as by welding or brazing.

Right shock absorber 141 may be a telescopic shock absorber and may include a right spring 142, a right spring post 143, and a right spring tube 144. Other types of shock absorbers may also be used. In the embodiment illustrated, right shock absorber 141 may extend downward and outward from the right end of forward suspension bracket 139 and connect to right lower wing 150. The lower end of right shock absorber 141 may connect to right lower wing 150 between right lower wing forward arm 151 and right lower wing aft arm 152. In the embodiment shown, the connection of right shock absorber 141 to right lower wing 150 is between the midpoint of right lower wing 150 and the connection between right lower wing 150 and right wheel bracket 155. Right shock absorber 141 may also extend between right upper wing forward arm 146 and right upper wing aft arm 147. Right upper wing 145 and right lower wing 150 may be configured to allow movement of forward right wheel assembly 180, while right suspension assembly 140 may be configured to generally restrain forward right wheel assembly 180 relative to forward frame 120. The right shock absorber 141 may be configured to absorb any impacts causing movement of forward right wheel assembly 180 relative to forward frame 120.

Left suspension assembly 160 may be the same or similar to right suspension assembly 140. Left suspension assembly 160 connects to forward frame 120 and to forward suspension bracket 139, and connects them to forward left wheel assembly 190. Left suspension assembly 160 may include a left upper wing 165, a left lower wing 170, a left wheel bracket 175, and a left shock absorber 161. Left upper wing 165 connects forward frame 120 to left wheel bracket 175. Left upper wing 165 may include a left upper wing forward arm 166, a left upper wing aft arm 167, a left upper wing inner tube 169 and a left upper wing outer tube 168. Left upper wing forward arm 166 may extend from the forward end of left upper wing inner tube 169 to the forward end of left upper wing outer tube 168. Left upper wing aft arm 167 may extend from the aft end of left upper wing inner tube 169 to the aft end of left upper wing outer tube 168. Left upper wing forward arm 166 and left upper wing aft arm 167 may be rectangular pieces of sheet metal, such as aluminum plates, and may have rounded corners or ends. Left upper wing forward arm 166 and left upper wing aft arm 167 may include multiple cutouts 138. Left upper wing inner tube 169 and left upper wing outer tube 168 may join left upper wing forward arm 166 and left upper wing aft arm 167 together. Left upper wing inner tube 169 and left upper wing outer tube 168 may be circular tubes and may be metallurgically bonded, such as by welding or brazing, to left upper wing forward arm 166 and left upper wing aft arm 167. Left upper wing outer tube 168 may be distal to left upper wing inner tube 169.

Left upper wing 165 may connect to left forward bracket 129 adjacent left upper wing aft arm 167 and to face plate 101 adjacent left upper wing forward arm 166 with left upper wing inner tube 169 extending between left forward bracket 129 and face plate 101. Left upper wing 165 may be bolted or otherwise connected to left forward bracket 129 and face plate 101 at left upper wing inner tube 169. Bearings may be placed to facilitate rotation between left upper wing inner tube 169 and the bolt or connector. Left upper wing 165 may be bolted or otherwise connected to left wheel bracket 175 at left upper wing outer tube 168. Bearings may also be placed to facilitate rotation between left upper wing outer tube 168 and the bolt or connector.

Left lower wing 170 may be located below left upper wing 165. Left lower wing 170 may also connect forward frame 120 to left wheel bracket 175. Left lower wing 170 may include a left lower wing forward arm 171, a left lower wing aft arm 172, a left lower wing inner tube 174 and a left lower wing outer tube 173. Left lower wing forward arm 171 may extend from the forward end of left lower wing inner tube 174 to the forward end of left lower wing outer tube 173. Left lower wing aft arm 172 extends from the aft end of left lower wing inner tube 174 to the aft end of left lower wing outer tube 173. Left lower wing forward arm 171 and left lower wing aft arm 172 may be rectangular pieces of sheet metal, such as aluminum plates, and may have rounded corners or ends. Left lower wing forward arm 171 and left lower wing aft arm 172 may include multiple cutouts 138. Left lower wing inner tube 174 and left lower wing outer tube 173 may join left lower wing forward arm 171 and left lower wing aft arm 172 together. Left lower wing inner tube 174 and left lower wing outer tube 173 may be circular tubes and may be metallurgically bonded, such as by welding or brazing, to left lower wing forward arm 171 and left lower wing aft arm 172. Left lower wing outer tube 173 may be distal to left upper wing inner tube 169.

Left lower wing 170 may connect to the bottom of left forward bracket 129 adjacent left lower wing aft arm 172 and to the bottom of face plate 101 adjacent left lower wing forward arm 171 with left lower wing inner tube 174 extending between left forward bracket 129 and face plate 101. Left lower wing inner tube 174 may also be located below left upper wing inner tube 169. Left lower wing 170 may be bolted or otherwise connected to left forward bracket 129 and face plate 101 at left lower wing inner tube 174. Bumper 103 may be attached to face plate 101 with the bolts or fasteners connecting right lower wing 150 and left lower wing 170 to face plate 101. Bearings may be placed to facilitate rotation between left lower wing inner tube 174 and the bolt or connector. Left lower wing 170 may be bolted or otherwise connected to left wheel bracket 175 at left lower wing outer tube 173. Bearings may also be placed to facilitate rotation between left lower wing outer tube 173 and the bolt or connector.

Left wheel bracket 175 may include a left bracket upper plate 176, a left bracket lower plate 177, a left forward bracket arm 178, and a left aft bracket arm 179. Left bracket upper plate 176 and left bracket lower plate 177 may be square or rectangular plates. Left bracket upper plate 176 and left bracket lower plate 177 may be parallel with a vertical gap there between. Left forward bracket arm 178 may be a vertical plate with the flat faces of the plate facing in the forward and aft directions. The upper and outer edge of left forward bracket arm 178 may connect to the forward and inner portion of left bracket upper plate 176. The lower and outer edge of left forward bracket arm 178 may connect to the forward and inner portion of left bracket lower plate 177.

Left aft bracket arm 179 may be a vertical plate with the flat faces of the plate facing in the forward and aft directions. The upper and outer edge of left aft bracket arm 179 may connect to the aft and inner portion of left bracket upper plate 176. The lower and outer edge of left aft bracket arm 179 may connect to the aft and inner portion of left bracket lower plate 177. Left bracket upper plate 176, left bracket lower plate, left forward bracket arm 178, and left aft bracket arm 179 may be a single integral piece or may be metallurgically bonded, such as by welding or brazing.

Left shock absorber 161 may be a telescopic shock absorber and may include left spring 162, left spring post 163, and left spring tube 164. Other types of shock absorbers may also be used. In the embodiment illustrated, left shock absorber 161 may connect to forward suspension bracket 139 distal to the connection to right shock absorber 141 and extend downward and outward from the left end of forward suspension bracket 139 and connect to left lower wing 170. The lower end of left shock absorber 161 may connect to left lower wing 170 between left lower wing forward arm 171 and left lower wing aft arm 172. In the embodiment shown, the connection of left shock absorber 161 to left lower wing 170 is between the midpoint of left lower wing 170 and the connection between left lower wing 170 and left wheel bracket 175. Left shock absorber 161 may also extend between left upper wing forward arm 166 and left upper wing aft arm 167. Left upper wing 165 and left lower wing 170 may be configured to allow movement of forward left wheel assembly 190, while left suspension assembly 160 may be configured to generally restrain forward left wheel assembly 190 relative to forward frame 120. The left shock absorber 161 may be configured to absorb any impacts causing movement of forward left wheel assembly 190 relative to forward frame 120.

Forward right wheel assembly 180 may connect to right suspension assembly 140 distal to forward frame 120 and forward suspension bracket 139. Forward right wheel assembly 180 may include a right steering bracket 181, a forward right wheel hub 184, a forward right wheel rim 185 located radially outward from forward right wheel hub, forward right wheel spokes 186 extending between forward right wheel rim 185 and forward right wheel hub 184, a forward right wheel tire 187 adjacent forward right wheel rim 185, a forward right wheel inner tube between forward right wheel tire 187 and forward right wheel rim 185, and a forward right wheel axle 188 connecting forward right wheel hub 184 to right steering bracket 181.

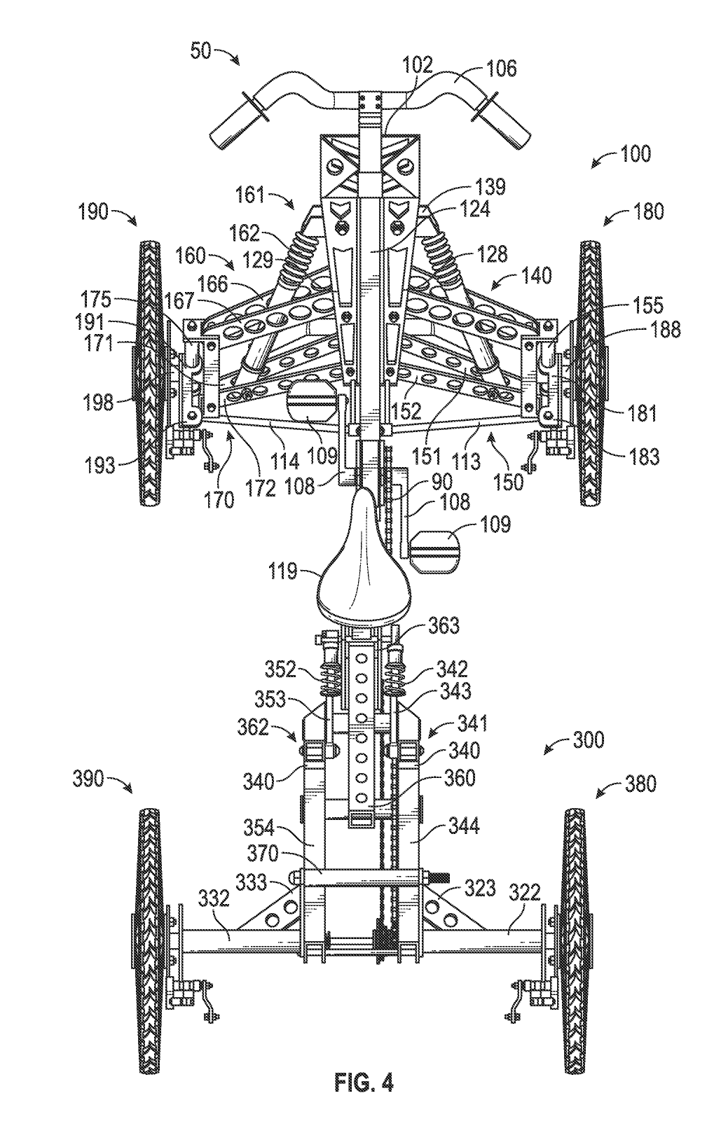

FIG. 4 is an alternative perspective view of the top of the quadracycle 50 of FIG. 1. Referring to FIGS. 3 and 4, right steering bracket 181 may include a right wheel tube 182, a right steering tube 189, and a right steering bracket extension 183. Right steering tube 189 may extend vertically between right bracket upper plate 156 and right bracket lower plate 157. Right wheel tube 182 may be bolted or otherwise connected to right wheel bracket 155. Right wheel tube 182 may bisect right steering tube 189 and may be configured to receive forward right wheel axle 188. Right steering bracket extension 183 may extend aft from right wheel tube 182 or right steering tube 189. The end of right steering bracket extension 183 opposite right wheel tube 182 may be moved or rotated by steering assembly 110 to rotate forward right wheel assembly 180 about the axis of right steering tube 189 to turn the quadracycle 50.

Forward left wheel assembly 190 may connect to left suspension assembly 160 distal to forward frame 120 and forward suspension bracket 139. Forward left wheel assembly 190 may include a left steering bracket 191, a forward left wheel hub 194, a forward left wheel rim 195 located radially outward from forward left wheel hub, forward left wheel spokes 196 extending between forward left wheel rim 195 and forward left wheel hub 194, a forward left wheel tire 197 adjacent forward left wheel rim 195, a forward left wheel inner tube between forward left wheel tire 197 and forward left wheel rim 195, and a forward left wheel axle 198 connecting forward left wheel hub 194 to left steering bracket 191.

Left steering bracket 191 may include a left wheel tube 192, a left steering tube 199, and a left steering bracket extension 193. Left steering tube 199 may extend vertically between left bracket upper plate 176 and left bracket lower plate 177. Left wheel tube 192 may be bolted or otherwise connected to left wheel bracket 175. Left wheel tube 192 may bisect left steering tube 199 and may be configured to receive forward left wheel axle 198. Left steering bracket extension 193 may extend aft from left wheel tube 192 or left steering tube 199. The end of left steering bracket extension 193 opposite left wheel tube 192 may be moved or rotated by steering assembly 110 to rotate forward left wheel assembly 190 about the axis of left steering tube 199 to turn the quadracycle 50.

Referring to FIG. 1, stem 104 may extend down through head tube 123. Handle bar 106 connects to the top end of stem 104. Stem 104 is configured to transfer rotation of handle bar 106 to steering assembly 110 to turn forward right wheel assembly 180 and forward left wheel assembly 190 simultaneously.

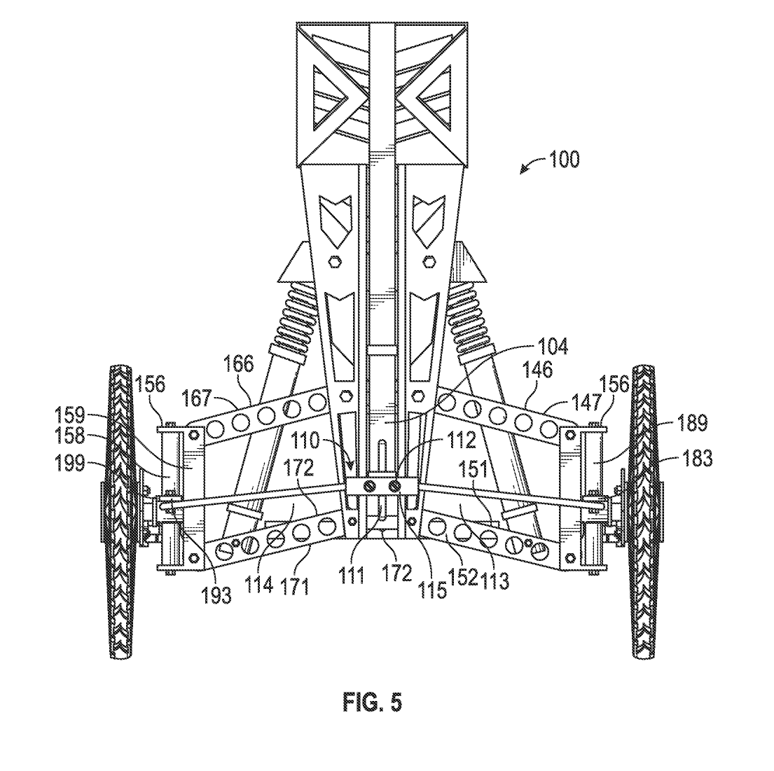

FIG. 5 is a perspective view of the aft side of a portion of forward assembly 100 of FIG. 1. Referring to FIG. 5, steering assembly 110 may include a steering rod 111, a steering clamp 112, a steering bracket 115, a right steering arm 113, and a left steering arm 114. Steering rod 111 may have a ‘C’ shape with each end of the ‘C’ shape being connected to the bottom of stem 104 and configured to rotate with stem 104. Steering clamp 112 may be looped around the middle portion of the ‘C’ shape of steering rod 111. Steering clamp 112 may have a ‘U’ shape with a first end of the ‘U’ shape connecting to an end of right steering arm 113 and a second end of the ‘U’ shape connecting to an end of left steering arm 114.

Steering bracket 115 may connect to both ends of steering clamp 112 adjacent right steering arm 113 and left steering arm 114. Steering clamp 112 may be threaded and may be secured to right steering arm 113, left steering arm 114 and steering bracket 115 with fasteners such as nuts. Other hardware may also be included to prevent or reduce relative rotation between stem 104, steering rod 111, and steering clamp 112. Right steering arm 113 connects to forward right wheel assembly 180. Right steering arm 113 may be a straight rod and may extend from steering clamp 112 to right steering bracket extension 183. Left steering arm 114 connects to forward left wheel assembly 190. Left steering arm 114 may be a straight rod and may extend from steering clamp 112 to left steering bracket extension 193.

Referring again to FIG. 1, forward chain wheel 107 may be connected to tube support member 125 adjacent right aft bracket 130 and may be configured to rotate relative to right aft bracket 130. Crank arms 108 extend from forward chain wheel 107. A pedal 109 attaches to an end of each crank arm 108.

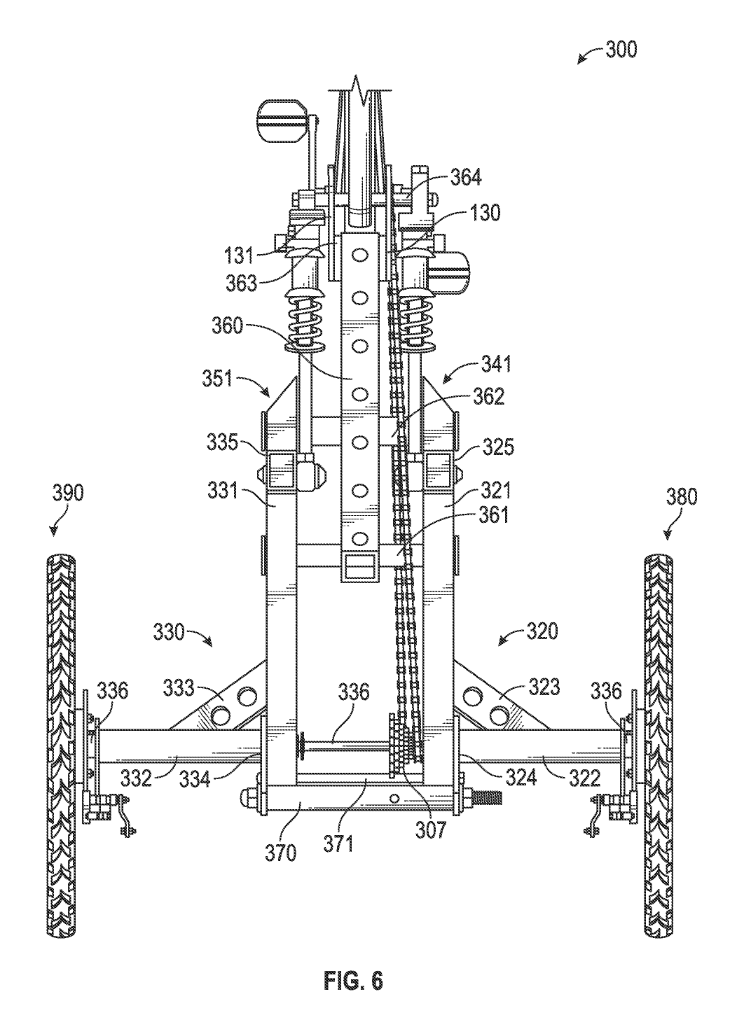

FIG. 6 is a perspective view of the rear assembly 300 of FIG. 1. Referring to FIGS. 1 and 6, rear assembly 300 may include a right rear frame 320, a left rear frame 330, a rear axle 336, a rear right wheel assembly 380, a rear left wheel assembly 390, an aft chain wheel 307, a chain tensioner, a rear suspension assembly 340, a rear bracket arm connector 370, and a rear tube connector 371. Right rear frame 320 may include a right rear tube 321, a right axle tube 322, a right support tube 323, a right rear bracket arm 324, and a right rear suspension arm 325. Right rear tube 321 may extend in the first horizontal direction from forward to aft. In the embodiment shown, right rear tube 321 is a rectangular tube. In other embodiments, right rear tube 321 may be a square or circular tube. The forward end of right rear tube 321 may be cut at an angle.

Right axle tube 322 may extend from right rear tube 321 near the aft end of right rear tube 321. In the embodiment illustrated, right axle tube 322 extends perpendicularly from right rear tube 321. Right axle tube 322 may be a circular or cylindrical tube. Right support tube 323 may be a rectangular tube and may extend at an angle between right rear tube 321 and right axle tube 322. In the embodiment illustrated, right support tube 323 forms approximately a forty-five degree angle with both right rear tube 321 and right axle tube 322.

Right rear bracket arm 324 may extend up from the joint between right rear tube 321 and right axle tube 322. Right rear bracket arm 324 may be a piece of sheet medal or a plate of metal and may include holes, cut-outs, or other decorative features. Right rear suspension arm 325 may be connected to right rear tube 321 and may extend up near the forward end of right rear tube 321. The various connections described above between the parts or elements of right rear frame 320 may be metallurgically bonded, such as by welding or brazing.

Left rear frame 330 may be spaced apart from the right rear frame 320. Left rear frame 330 may include a left rear tube 331, a left axle tube 332, a left support tube 333, a left rear bracket arm 334, and a left rear suspension arm 335. Left rear tube 331 may extend in the first horizontal direction from forward to aft. In the embodiment shown, left rear tube 331 is a rectangular tube. In other embodiments, left rear tube 331 may be a square or circular tube. The forward end of left rear tube 331 may be cut at an angle.

Left axle tube 332 may extend from left rear tube 331 near the aft end of left rear tube 331. In the embodiment illustrated, left axle tube 332 extends perpendicularly from left rear tube 331. Left axle tube 332 may be a circular or cylindrical tube. Left support tube 333 may be a rectangular tube and may extend at an angle between left rear tube 331 and left axle tube 332. In the embodiment illustrated, left support tube 333 forms approximately a forty-five degree angle with both left rear tube 331 and left axle tube 332.

Left rear bracket arm 334 may extend up from the joint between left rear tube 331 and left axle tube 332. Left rear bracket arm 334 may be a piece of sheet medal or a plate of metal and may include holes, cut-outs, or other decorative features. Left rear suspension arm 335 may be connected to left rear tube 331 and may extend up near the forward end of left rear tube 331. The various connections described above between the parts or elements of left rear frame 330 may be metallurgically bonded, such as be welding or brazing.

Rear right wheel assembly 380 may include a rear right wheel hub 384, a rear right wheel rim 385 located radially outward from rear right wheel hub, a rear right wheel spokes 386 extending between rear right wheel rim 385 and rear right wheel hub 384, a rear right wheel tire 387 adjacent rear right wheel rim 385, and a rear right wheel inner tube between rear right wheel tire 387 and rear right wheel rim 385.

Rear left wheel assembly 390 includes rear left wheel hub 394, rear left wheel rim 395 located radially outward from rear left wheel hub, rear left wheel spokes 396 extending between rear left wheel rim 395 and rear left wheel hub 394, rear left wheel tire 397 adjacent rear left wheel rim 395, and a rear left wheel inner tube between rear left wheel tire 397 and rear left wheel rim 395.

Rear axle 336 extends from rear right wheel hub 384 to rear left wheel hub 394 through right rear frame 320, such as through right axle tube 322, and through left rear frame 330, such as through left axle tube 332. Each wheel assembly may include a braking mechanism. Rear right wheel assembly 380 may connect to an end of rear axle 336. Rear left wheel assembly 390 may connect to the opposite end of rear axle 336, distal to the rear right wheel assembly 380.

Right rear frame 320 and left rear frame 330 may be connected by rear bracket arm connector 370, rear tube connector 371, and elements of rear suspension assembly 340. Rear bracket arm connector 370 may extend between right rear bracket arm 324 and left rear bracket arm 334 at the ends of right rear bracket arm 324 and left rear bracket arm 334 opposite the connections of right rear bracket arm 324 to right rear tube 321 and left rear bracket arm 334 to left rear tube 331. Rear bracket arm connector 370 may be a cylindrical or circular tube and may be connected, such as by bolting, to right rear bracket arm 324 and left rear bracket arm 334.

Rear tube connector 371 may extend between the aft ends of right rear tube 321 and left rear tube 331. Rear tube connector 371 may be a cylindrical or circular rod and may be connected, such as by bolting, to right rear tube 321 and left rear tube 331.

Rear suspension assembly 340 may include a rear suspension tube 360, a first rear connector 361, a second rear connector 362, an assembly connector 363, a rear suspension cross-bar 364, a rear right shock absorber 341, and a rear left shock absorber 351. Rear suspension tube 360 may extend parallel to right rear tube 321 and left rear tube 331 and at least partially there between. An aft portion of rear suspension tube 360 may be located between forward portions of right rear tube 321 and left rear tube 331. First rear connector 361 may extend through and connect right rear tube 321, rear suspension tube 360 adjacent the aft end of rear suspension tube 360, and left rear tube 331. Second rear connector 362 may extend through and connect right rear tube 321 adjacent the forward end of right rear tube 321, rear suspension tube 360, and left rear tube 331 adjacent the forward end of left rear tube 331. First rear connector 361 and second rear connector 362 may also connect right rear frame 320 to left rear frame 330.

Assembly connector 363 connects to forward frame 120 and may extend through and connect to right aft bracket 130 adjacent forward chain wheel 107, rear suspension tube 360 adjacent the forward end of rear suspension tube 360 and distal to the aft end of rear suspension tube 360, and left aft bracket 131 connecting forward assembly 100 to rear assembly 300. Assembly connector 363 may be configured to allow relative rotation between forward assembly 100 and rear assembly 300. Rear suspension cross-bar 364 connects to forward frame 120. Rear suspension cross-bar 364 may connect to and extend between right aft bracket 130 and left aft bracket 131. In the embodiment illustrated, rear suspension cross-bar 364 extends through and protrudes out from the ends of right aft bracket 130 and left aft bracket 131 distal to forward chain wheel 107.

Rear right shock absorber 341 connects rear suspension cross-bar 364 to right rear frame 320. Rear right shock absorber 341 may be a telescopic shock absorber and may include rear right spring 342, rear right spring post 343, and rear right spring tube 344. Other types of shock absorbers may also be used. In the embodiment illustrated, rear right shock absorber 341 may extend downward and aft from the right end of rear suspension cross-bar 364 to right rear suspension arm 325 further connecting forward assembly 100 to rear assembly 300.

Rear left shock absorber 351 connects rear suspension cross-bar 364 to left rear frame 330. Rear left shock absorber 351 may be a telescopic shock absorber and may include rear left spring 352, rear left spring post 353, and rear left spring tube 354. Other types of shock absorbers may also be used. In the embodiment illustrated, rear left shock absorber 351 may extend downward and aft from the left end of rear suspension cross-bar 364 to left rear suspension arm 335 even further connecting forward assembly 100 to rear assembly 300. Rear right shock absorber 341 and rear left shock absorber 351 are configured to limit or reduce the relative rotation between forward assembly 100 and rear assembly 300.

Aft chain wheel 307 may be connected to rear axle 336 adjacent to right rear tube 321 between right rear tube 321 and left rear tube 331. Chain tensioner may be located adjacent aft chain wheel 307 and is configured to maintain tension in chain 90. Chain 90 extends around forward chain wheel 107 and aft chain wheel 307 and is configured to turn and drive rear axle 336, rear right wheel assembly 380 and rear left wheel assembly 390.

One or more of the above components (or their subcomponents) may be made from aluminum, stainless steel, or similar metals.

A cycle such as quadracycle 50 including a forward right wheel assembly 180, a forward left wheel assembly 190, a rear right wheel assembly 380, and a rear left wheel assembly 390 may provide for a more stable and smooth ride. The linkages between right forward bracket 128, right upper wing 145, right lower wing 150, and right wheel bracket 155 combined with right shock absorber 141 may permit forward right wheel assembly 180 to move independent from the rest of the assembly. Similarly, the linkages between left forward bracket 129, left upper wing 165, left lower wing 170, and left wheel bracket 175 combined with left shock absorber 161 may permit forward left wheel assembly 190 to move independent from the rest of the assembly. The independent movement of forward right wheel assembly 180 and forward left wheel assembly 190 may prevent or reduce the bumps felt by the rider and may provide stability to the quadracycle 50 during operation of quadracycle 50. Similarly, the connection of rear assembly 300 to right aft bracket 130 and left aft bracket 131 through rear suspension assembly 340 may allow some independent movement of rear assembly 300, which may reduce the bumps felt by the rider and may provide stability to the quadracycle 50 during operation of quadracycle 50.

Quadracycle 50 may be configured with various devices for carrying sporting equipment, a second rider, or other items. For example, a second seat such as an infant seat for carrying an infant or a toddler may be attached to rear suspension cross-bar 364 and rear bracket arm connector 370.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art.

We claim:

1. A quadracycle, comprising:
a forward assembly including
a forward frame including
a cross tube extending in a first horizontal direction,
a forward suspension bracket connected to the forward frame and extending in a second horizontal direction, perpendicular to the first horizontal direction,
a right suspension assembly including
a right upper wing connected to the forward frame,
a right lower wing connected to the forward frame,
a right wheel bracket connected to the right upper wing and the right lower wing, and
a right shock absorber connected to an end of the forward suspension bracket and to the right lower wing,
a left suspension assembly including
a left upper wing connected to the forward frame,
a left lower wing connected to the forward frame,
a left wheel bracket connected to the left upper wing and the left lower wing, and
a left shock absorber connected to an end of the forward suspension bracket, distal to the right shock absorber connection, and to the left lower wing,
a forward right wheel assembly connected to the right wheel bracket,
a forward left wheel assembly connected to the left wheel bracket,
a steering assembly including a right steering arm connected to the forward right wheel assembly and a left steering arm connected to the forward left wheel assembly,
a handle bar, and
a stem connecting the handle bar to the steering assembly; and
a rear assembly including
a right rear frame,
a left rear frame spaced apart from the right rear frame in the second horizontal direction,
a rear tube connector connecting the right rear frame to the left rear frame,
a rear suspension assembly also connecting the right rear frame to the left rear frame and connecting the forward assembly to the rear assembly,
a rear axle extending through the right rear frame and through the left rear frame,
a rear right wheel assembly connected to the rear axle, and
a rear left wheel assembly connected to the rear axle distal to the rear right wheel assembly.

2. The quadracycle of claim 1, wherein:
the right upper wing includes
a right upper wing forward arm,
a right upper wing aft arm,
a right upper wing inner tube joining the right upper wing forward arm to the right upper wing aft arm, the right upper wing inner tube being bolted to the forward frame, and
a right upper wing outer tube joining the right upper wing forward arm to the right upper wing aft arm distal to the right upper wing inner tube, the right upper wing outer tube being bolted to the right wheel bracket; and
the left upper wing includes
a left upper wing forward arm,
a left upper wing aft arm,
a left upper wing inner tube joining the left upper wing forward arm to the left upper wing aft arm, the left upper wing inner tube being bolted to the forward frame, and
a left upper wing outer tube joining the left upper wing forward arm to the left upper wing aft arm distal to the left upper wing inner tube, the left upper wing outer tube being bolted to the left wheel bracket.

3. The quadracycle of claim 2, wherein:
the right lower wing includes
a right lower wing forward arm,
a right lower wing aft arm,
a right lower wing inner tube joining the right lower wing forward arm to the right lower wing aft arm, the right lower wing inner tube being bolted to the forward frame, and
a right lower wing outer tube joining the right lower wing forward arm to the right lower wing aft arm distal to the right lower wing inner tube, the right lower wing outer tube being bolted to the right wheel bracket; and
the left lower wing includes
a left lower wing forward arm,
a left lower wing aft arm,
a left lower wing inner tube joining the left lower wing forward arm to the left lower wing aft arm, the left lower wing inner tube being bolted to the forward frame, and
a left lower wing outer tube joining the left lower wing forward arm to the left lower wing aft arm distal to the left lower wing inner tube, the left lower wing outer tube being bolted to the left wheel bracket.

4. The quadracycle of claim 1, wherein:
the right rear frame includes
a right rear tube extending in the first horizontal direction, and
a right axle tube extending from the right rear tube in the second horizontal direction; and
the left rear frame includes
a left rear tube extending in the first horizontal direction, and
a left axle tube extending from the left rear tube opposite the second horizontal direction.

5. The quadracycle of claim 4, wherein the rear suspension assembly comprises:
a rear suspension tube extending parallel to the right rear tube and the left rear tube and at least partially there between;
a first rear connector extending through and connecting the right rear tube, the rear suspension tube adjacent an aft end of the rear suspension tube, and the left rear tube;
a second rear connector extending through and connecting the right rear tube adjacent a first forward end of the right rear tube, the rear suspension tube, and the left rear tube adjacent a second forward end of the left rear tube;
an assembly connector extending through the rear suspension tube adjacent a third forward end of the rear suspension tube distal to the aft end of the rear suspension tube;
a rear suspension cross-bar connected to the forward frame;
a rear right shock absorber connecting the rear suspension cross-bar to the right rear frame; and
a rear left shock absorber connecting the rear suspension cross-bar to the left rear frame.

6. The quadracycle of claim 1, wherein the right shock absorber and the left shock absorber are telescopic shock absorbers.

7. The quadracycle of claim 1, wherein the steering assembly further includes:
a steering rod having a ‘C’ shape, with each end connected to the stem;
a steering clamp having a ‘U’ shape looped between the steering rod and the stem with a first end connected to the right steering arm and a second end connected to the left steering arm; and
a steering bracket connected to the first end and the second end.

8. A quadracycle, comprising:
a forward assembly including
a forward frame extending in a first horizontal direction,
a forward suspension bracket connected to the forward frame,
a right suspension assembly connected to the forward frame and the forward suspension bracket,
a left suspension assembly connected to the forward frame and the forward suspension bracket,
a forward right wheel assembly connected to the right suspension assembly distal to the forward frame, and
a forward left wheel assembly connected to the left suspension assembly distal to the forward frame; and
a rear assembly including
a right rear frame including
a right rear tube extending in the first horizontal direction, and
a right axle tube extending from the right rear tube in a second horizontal direction perpendicular to the first horizontal direction,
a left rear frame spaced apart from the right rear frame opposite the second horizontal direction, the left rear frame including
a left rear tube extending in the first horizontal direction, and
a left axle tube extending from the left rear tube opposite the second horizontal direction,
a rear tube connector connecting the right rear frame to the left rear frame,
a rear suspension assembly including
a rear suspension tube extending parallel to the right rear tube and the left rear tube and at least partially there between,
a first rear connector extending through and connecting the right rear tube, the rear suspension tube adjacent an aft end of the rear suspension tube, and the left rear tube,
a second rear connector extending through and connecting the right rear tube adjacent a first forward end of the right rear tube, the rear suspension tube, and the left rear tube adjacent a second forward end of the left rear tube,
an assembly connector extending through the rear suspension tube adjacent a third forward end of the rear suspension tube distal to the aft end of the rear suspension tube,
a rear suspension cross-bar connected to the forward frame,
a rear right shock absorber connecting the rear suspension cross-bar to the right rear frame, and
a rear left shock absorber connecting the rear suspension cross-bar to the left rear frame,
a rear axle extending through the right axle tube and through the left axle tube,
a rear right wheel assembly connected to the rear axle, and
a rear left wheel assembly connected to the rear axle distal to the rear right wheel assembly.

9. The quadracycle of claim 8, wherein the rear right shock absorber and the rear left shock absorber are telescopic shock absorbers.

10. The quadracycle of claim 8, wherein:
the right suspension assembly includes
a right upper wing connected to the forward frame,
a right lower wing connected to the forward frame,
a right wheel bracket connected to the right upper wing and the right lower wing, and
a right shock absorber connected to an end of the forward suspension bracket and to the right lower wing; and
the left suspension assembly includes
a left upper wing connected to the forward frame,
a left lower wing connected to the forward frame,
a left wheel bracket connected to the left upper wing and the left lower wing, and
a left shock absorber connected to an end of the forward suspension bracket, distal to the right shock absorber connection, and to the left lower wing.

11. The quadracycle of claim 10, wherein:
the right upper wing includes
a right upper wing forward arm,
a right upper wing aft arm,
a right upper wing inner tube joining the right upper wing forward arm to the right upper wing aft arm, the right upper wing inner tube being bolted to the forward frame, and
a right upper wing outer tube joining the right upper wing forward arm to the right upper wing aft arm distal to the right upper wing inner tube, the right upper wing outer tube being bolted to the right wheel bracket; and
the left upper wing includes
a left upper wing forward arm,
a left upper wing aft arm,
a left upper wing inner tube joining the left upper wing forward arm to the left upper wing aft arm, the left upper wing inner tube being bolted to the forward frame, and
a left upper wing outer tube joining the left upper wing forward arm to the left upper wing aft arm distal to the left upper wing inner tube, the left upper wing outer tube being bolted to the left wheel bracket.

12. The quadracycle of claim 11, wherein:
the right lower wing includes
a right lower wing forward arm,
a right lower wing aft arm,
a right lower wing inner tube joining the right lower wing forward arm to the right lower wing aft arm, the right lower wing inner tube being bolted to the forward frame, and
a right lower wing outer tube joining the right lower wing forward arm to the right lower wing aft arm distal to the right lower wing inner tube, the right lower wing outer tube being bolted to the right wheel bracket; and
the left lower wing includes
a left lower wing forward arm,
a left lower wing aft arm,
a left lower wing inner tube joining the left lower wing forward arm to the left lower wing aft arm, the left lower wing inner tube being bolted to the forward frame, and
a left lower wing outer tube joining the left lower wing forward arm to the left lower wing aft arm distal to the left lower wing inner tube, the left lower wing outer tube being bolted to the left wheel bracket.

13. The quadracycle of claim 12, wherein the forward assembly further comprises:
a handle bar;
a stem connected to the handle bar; and
a steering assembly including
a right steering arm connected to the forward right wheel assembly,
a left steering arm connected to the forward left wheel assembly,
a steering rod having a ‘C’ shape, with each end connected to the stem,
a steering clamp having a ‘U’ shape looped between the steering rod and the stem with a first end connected to the right steering arm and a second end connected to the left steering arm, and
a steering bracket connected to the first end and the second end.

14. The quadracycle of claim 8, wherein the right rear frame includes a right support tube extending at an angle between the right rear tube and the right axle tube, and the left rear frame includes a left support tube extending at a second angle between the left rear tube and the left axle tube.

15. A quadracycle, comprising:
a forward assembly including
a forward frame including
a cross tube extending in a first horizontal direction,
a head tube connected to the cross tube and extending in a vertical direction perpendicular to the first horizontal direction,
a down tube connected to the head tube and extending below the cross tube at an angle such that a forward end of the down tube connected to the head tube is closer to the cross tube than an aft end of the down tube,
a tube support member extending from the cross tube to the down tube, the tube support member with connections to the cross tube and the down tube being distal to the head tube,
a right forward bracket extending in the vertical direction adjacent the head tube and connecting to the cross tube and the down tube, the right forward bracket including an ‘L’ shape with a first leg extending in the first horizontal direction and a second leg extending in a second horizontal direction perpendicular to the first horizontal direction and the vertical direction, and
a left forward bracket extending in the vertical direction adjacent the head tube, opposite the right forward bracket, and connecting to the cross tube and the down tube, the left forward bracket including a second ‘L’ shape with a third leg extending in the first horizontal direction and a fourth leg extending in the direction opposite the second horizontal direction,
a forward suspension bracket extending in the second horizontal direction and connected to the right forward bracket and the left forward bracket,
a face plate extending in the vertical direction, the face plate being connected to the forward suspension bracket,
a right suspension assembly connected to the right forward bracket, the face plate, and the forward suspension bracket,
a left suspension assembly connected to the left forward bracket, the face plate, and the forward suspension bracket,
a forward right wheel assembly connected to the right suspension assembly distal to the forward frame, and
a forward left wheel assembly connected to the left suspension assembly distal to the forward frame; and
a rear assembly including
a right rear frame including
a right rear tube extending in the first horizontal direction,
a right axle tube extending from the right rear tube in the second horizontal direction, and
a right support tube extending at a first angle between the right rear tube and the right axle tube,
a left rear frame spaced apart from the right rear frame opposite the second horizontal direction, the left rear frame including
a left rear tube extending in the first horizontal direction,
a left axle tube extending from the left rear tube opposite the second horizontal direction, and
a left support tube extending at a second angle between the left rear tube and the left axle tube,
a rear tube connector connecting the right rear frame to the left rear frame,
a rear suspension assembly also connecting the right rear frame to the left rear frame and connecting the forward assembly to the rear assembly,
a rear axle extending through the right rear frame and through the left rear frame,
a rear right wheel assembly connected to the rear axle, and
a rear left wheel assembly connected to the rear axle distal to the rear right wheel assembly.

16. The quadracycle of claim 15, wherein the forward frame further includes:
a seat support member extending from the cross tube adjacent the connection to the tube support member; and
a seat tube connected to the seat support member distal to the cross tube, the seat tube being oriented in the vertical direction and being configured to receive a seat post to support a seat.

17. The quadracycle of claim 15, wherein:
the right suspension assembly includes
a right upper wing connected to the right forward bracket and the face plate,
a right lower wing connected to the right forward bracket and the face plate,
a right wheel bracket connected to the right upper wing and the right lower wing, and
a right shock absorber connected to an end of the forward suspension bracket and to the right lower wing; and
the left suspension assembly includes
a left upper wing connected to the left forward bracket and the face plate,
a left lower wing connected to the left forward bracket and the face plate,
a left wheel bracket connected to the left upper wing and the left lower wing, and
a left shock absorber connected to an end of the forward suspension bracket, distal to the right shock absorber connection, and to the left lower wing.

18. The quadracycle of claim 15, wherein the forward frame further includes:
a right aft bracket connected to the down tube distal the head tube;
a left aft bracket connected to the down tube distal the head tube, situated on a side of down tube opposite the right aft bracket.

19. The quadracycle of claim 18, wherein the rear suspension assembly comprises:
a rear suspension tube extending parallel to the right rear tube and the left rear tube and at least partially there between;
a first rear connector extending through and connecting the right rear tube, the rear suspension tube adjacent an aft end of the rear suspension tube, and the left rear tube;
a second rear connector extending through and connecting the right rear tube adjacent a second forward end of the right rear tube, the rear suspension tube, and the left rear tube adjacent a third forward end of the left rear tube;
an assembly connector extending through the rear suspension tube adjacent a fourth forward end of the rear suspension tube distal to the aft end of the rear suspension tube and connected to the forward frame;
a rear suspension cross-bar connected to and extending between the right aft bracket and the left aft bracket;
a rear right shock absorber connecting the rear suspension cross-bar to the right rear frame; and
a rear left shock absorber connecting the rear suspension cross-bar to the left rear frame.

20. The quadracycle of claim 15, wherein the forward assembly further comprises a steering assembly including:
a right steering arm connected to the forward right wheel assembly;
a left steering arm connected to the forward left wheel assembly;
a steering rod having a ‘C’ shape, with each end connected to a stem;
a steering clamp having a ‘U’ shape looped between the steering rod and the stem with a first end connected to the right steering arm and a second end connected to the left steering arm; and
a steering bracket connected to the first end and the second end.
